(19) United States
(12) Patent Application Publication
(10) Pub. No.: US 2010/0318411 A1
(43) Pub. Date: Dec. 16, 2010

(54) Community Philanthropy System & Process

(76) Inventors: MICHAEL A. PINK, Chicago, IL (US); SHARON L. PORTER, Chicago, IL (US)

Correspondence Address: BEEM PATENT LAW FIRM, 53 W. JACKSON BLVD., SUITE 1352, CHICAGO, IL, 60604-3787, US

(21) Appl. No.: 12/485,570

(22) Filed: Jun. 16, 2009

(51) Int. Cl. G06Q 40/00; G06Q 99/00; G06Q 10/00; G06F 17/30; G06F 15/16; G06Q 50/00

(52) U.S. Cl. 705/12; 705/30; 705/35; 705/39; 709/206; 707/955; 707/912

(57) ABSTRACT

A computer-implemented process and system for the distribution of resources such as funds to not-for-profit (NFP) entities or other organizations. The system may include a resource accumulation module for acquiring and keeping track of resources, a resource division module for initially determining what to do with resources that have been acquired, an education module for teaching users about the entities or their respective causes, an evaluation module for determining whether a user is eligible to vote on the distribution of resources, and a voting module through which users may choose the resource recipients. In one embodiment, resources may be obtained at least in part from the commissions generated by real estate transactions. In addition, users and/or voters may include students around the world, and organizations may include various NFPs, also located around the world.

### BACKGROUND OF THE INVENTION

1. Field of the Invention

The present invention is directed to a system and method for the disbursement of philanthropic funds via public voting over a computer network.

2. Description of the Related Art

Not-for-profit groups receive funding from myriad sources, including efforts by their development officers, unsolicited donations, and corporate sponsorships. These groups take in this funding and use at least a portion of it to work on causes they have chosen, from helping to find cures for disease, to providing food and shelter for needy individuals, to preserving natural resources. Oftentimes, individuals or groups providing donations may have only cursory knowledge of the causes being served or of the organizations themselves. This limited knowledge also may serve as a deterrent to potential donors who may forsake donating because they do not know how their donations will be used or because, perhaps selfishly, they feel that they are not benefiting from a donation to a random entity.

A second aspect of philanthropy may relate to community service, where the resources being donated may be time and energy instead of money or other goods. In order to provide a greater desire to participate actively in the causes supported by NFPs, entities like THE LEAGUE have provided tools such as http://learningtogive.org/ to provide lesson plans to educate students about the benefits of service and to instill in these students a desire to “do good” and “make a difference.” These lesson plans may be viewed as relatively static and dull. In addition, while admirable, the community service advocated by these plans may be focused locally and may fail to recognize that there may be significant similarities among people in different age groups, geographies, socio-economic conditions, etc.

What is needed is a system and/or process that overcomes the drawbacks described above.

### BRIEF SUMMARY OF THE INVENTION

A web-based community for social awareness, consciousness and responsibility on the part of individuals and businesses.

In one aspect of the invention, a system for the disbursement of philanthropic funds via public voting over a computer network may comprise: a resource accumulation module; an education module; an evaluation module; and a voting module. The system also may include a resource division module and a recordation module. Further, the system may include a social interaction or networking module, allowing users to communicate with one another. Moreover, the system may have an information repository from which users can obtain desired information relating, inter alia, to socially conscious subjects, activities and/or businesses.

In another aspect of the invention, a process for the disbursement of philanthropic funds via public voting over a computer network may comprise: accumulating resources from a plurality of sources; allocating at least a portion of the resources to an election, wherein candidates for the election comprise a plurality of not-for-profit entities; educating users about the plurality of not-for-profit entities and/or the causes those entities serve; evaluating the users for knowledge about the plurality of not-for-profit entities and/or causes; allowing the users to vote for at least one of the plurality of not-for-profit entities/causes to receive the allocated resources; tabulating the votes of the users to determine a disbursement of resources, which may include, e.g., a proportional allocation or a winner-takes-all disbursement for at least one winning not-for-profit entity; and distributing at least a portion of the allocated resources to the at least one winning not-for-profit entity.

These and other features and advantages are evident from the following description of the present invention, with reference to the accompanying drawings.

### BRIEF DESCRIPTION OF THE SEVERAL VIEWS OF THE DRAWINGS

FIG. 1 is a screenshot of a mock-up of one embodiment of a home page of a system according to the present invention.

FIG. 2 is a screenshot of a mock-up of one embodiment of a sign-in page for accessing or joining the system.

FIG. 3 is a screenshot of a mock-up of one embodiment of a registration page for new users.

FIG. 4 is a screenshot of a mock-up of one embodiment of a visual display representing components of an election module.

### DETAILED DESCRIPTION

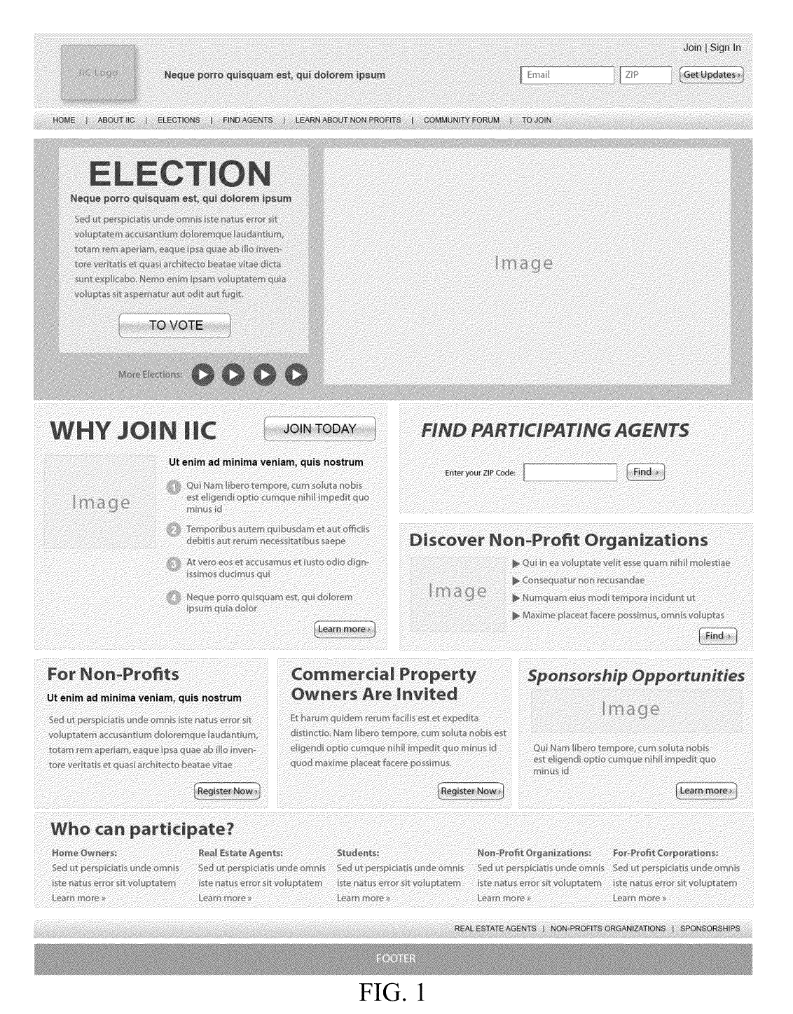

As seen in the example of FIG. 1, a computer-implemented process and system for the distribution of resources such as funds to not-for-profit (NFP) groups or other organizations. The system may include a resource accumulation module for acquiring and keeping track of resources, a resource division module for initially determining what to do with resources that have been acquired, an education module for teaching users about the groups or their respective causes, an evaluation module for determining whether a user is eligible to vote on the distribution of resources, and a voting module through which users may choose the resource recipients. In one embodiment, resources may be obtained at least in part from the commissions generated by real estate transactions. In addition, users and/or voters may include students around the world, and organizations may include various NFPs, also located around the world.

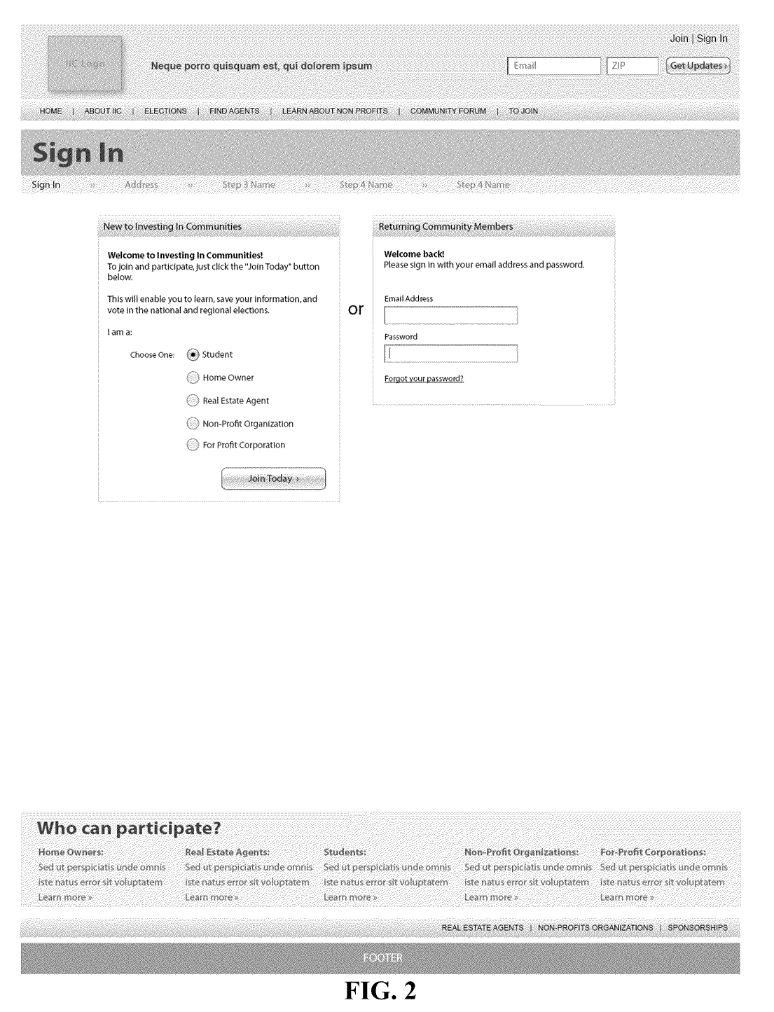

Entities that may be considered for eligibility to one or more aspects of the system may include licensed real estate professionals, their sponsoring brokers, respective trade groups, commercial building owners and managers, their respective employers, trade groups, individual professionals, their companies and trade groups. In one embodiment, each of these groups may be involved in a single area of business, e.g., real estate. However, other groups that have more ancillary connections to the area of business also may be considered for eligibility. In the real estate model, these may include, e.g., individuals, companies, and trade groups involved in architecture, law, material supply, maintenance, finance, mortgage, construction, and businesses of any other sort that may be involved in the use and/or commerce of real estate. As seen in FIG. 2, the system may prompt users to identify the category to which they belong, which selection may affect the system resources and opportunities available to those users.

In addition, other entities that may use or benefit from the system may include students, who may be part of larger classrooms, grades, schools, districts, and/or other chapters. Further entities that may use or benefit from the system may include NFPs and their supporters. Moreover, aspects of the system may be publicly available to non-paying users, although not all aspects may be available. For example, these users may have access to the education module to learn about the various NFPs and their causes but not to the voting module. In addition, these users may have access to a database of information on participating entities such as contributing real estate professionals. This access may be useful in forming a directory of preferred providers to help these users find a professional to represent them in a future transaction, which may serve as a source of a future contribution of resources to the system. As seen in FIG. 1, this directory may be searchable by members of the public, who may become users in the future by virtue of their selection and use of a preferred provider.

Resource Accumulation Module

Before being able to distribute resources to participating organizations, those resources first should be acquired and accumulated. For present purposes, resources may be described or represented as monetary funds, but the system and process may work equally as well in distributing other types of resources.

Resources may be acquired from various sources that relate to providing access to the system or exposure by the system. These sources may include, inter alia, membership and participation fees, charitable donations, sponsorships, advertising, monetization of internet traffic, and sale of goods or services to users, members, or other participants and/or the public. Membership and participation fees may be calculated as a flat-fee or may be calculated on a scaled or tiered structure. For example, a participation fee may be levied against commercial transaction consumers in order to allow the consumers' employees to vote on distribution of resources, and the number of employees may determine the amount of the fee. In one embodiment, the participation fee may be graduated, e.g., structured in tiers, whereby a company with 1-10 employees may pay a predetermined amount, a company with 11-25 employees may pay a larger predetermined amount, a company with 26-50 employees may pay a still larger predetermined amount, and so on. In another embodiment, registration or participation of, e.g., NFP users may be made on a sliding scale on the basis of annual budget.

Alternatively, participation fees may be tiered to provide different levels of recognition. For example, the system may provide silver, gold and platinum levels of participation for increasing participation fees. Although a participant's fee may be higher to be recognized as a platinum member, this recognition may have value to the participant that, by itself, justifies the increased expense. These higher fees also may benefit the participants by affording greater system visibility or exposure as it relates to other system users, e.g., in the form of the designation of a preferred status or search results, advertising space or other display space allocated to the participant.

Additionally, membership and participation fees may be based, at least in part, on the nature of the constituency to which the participant belongs. For example, the amount of the fee may be related, e.g., directly proportional, to a participant's annual budget or revenues, the nature of its funding sources, etc. Moreover, participation fees may be assessed on a periodic basis or may be a one-time occurrence. Participation fees also may be assessed or not depending on the category to which the participant belongs. For example, in one embodiment, all registrants except students may be required to pay some form of participation fee. In another embodiment, a participation fee may be required for all registrants and/or users.

Other funding may be derived from internet advertising, including, among other things, payment for banner-type ads, strategic positioning of ads or NFP descriptions in relation to other ads or descriptions, etc., each of which may be well-known in the art. Similar to participation fees, advertising fees may be tiered to determine the advertiser's level of visibility.

Advertisers may include subscribers or participants seeking a portion of the philanthropic fund disbursement, other participants of the system that are not seeking disbursements, and outside entities seeking exposure but otherwise unrelated to the system. In addition to funds collected through advertising, a higher participation fee and/or transaction-related percentage, described below, may be charged to allow for a greater degree of public exposure being afforded to that participant, through various system-related methods including prioritized ranking or display, larger displays, allocation of additional space for providing information to other users about the participant, etc.

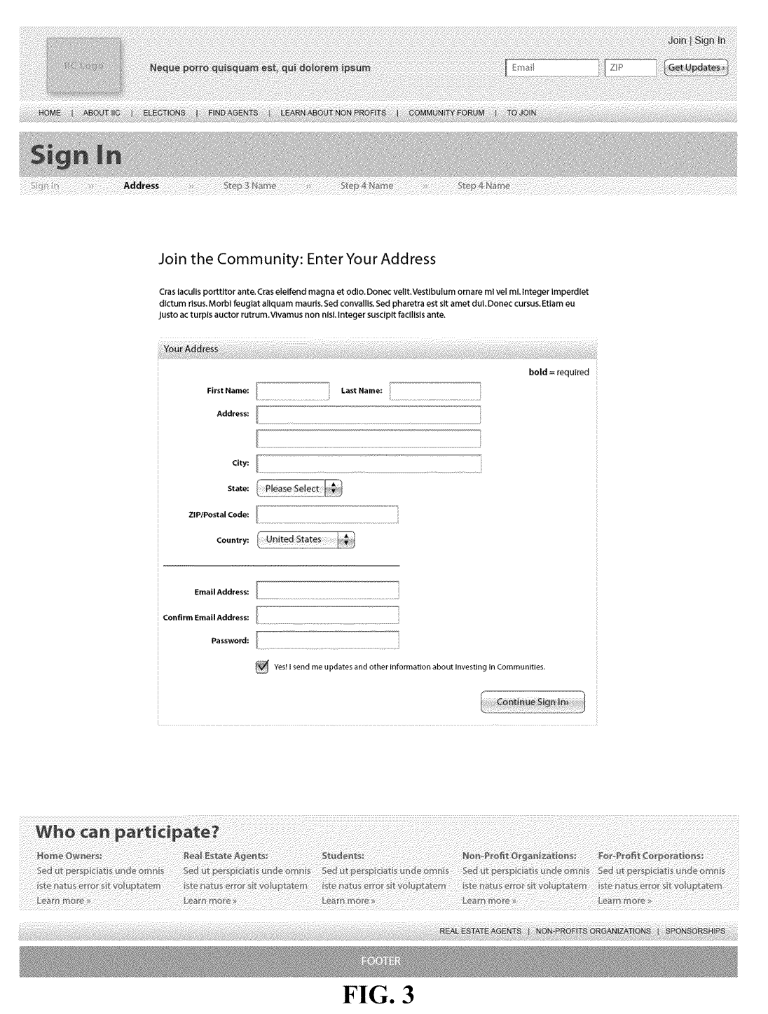

In addition, turning to FIG. 3, system users may be required to register to gain access to the system, at which time they may be required to provide biographical, demographical or other information, including, e.g., age and zip code. Users also may be prompted to provide other identifying information, including income level, marital status, last grade of school completed, etc. This information may be used to provide targeted advertising, for which a premium fee may be required, thereby further enhancing resource accumulation. Conversely, this information may be used to restrict advertising to prevent certain users (e.g., younger students) from being exposed to that advertising.

Moreover, the system may include an online store for the sale of various goods, including promotional items or memorabilia. The system further may serve as a marketplace for the sale of goods and services produced or offered by socially responsible sources. Proceeds from the sale of these goods and services may serve as a further source of resources to help fund the philanthropic goals of the system.

Funds also may be derived from external sources and accumulated into the system. For example, funds may be derived from the commissions generated from real estate transactions.

In this embodiment, a stream of funds may result from certain real estate transactions. The real estate-related funds may be derived from a percentage of the commissions that are paid to the principal's brokers involved with those transactions. These transaction-related funds may be provided voluntarily by, for example, the tenant's broker or a similar representative or, alternatively, may be required of the broker as a pre-condition for the opportunity to broker a transaction and receive the remaining portion of the commission. In either case, the system benefits by obtaining funds; the broker benefits by receiving a business opportunity and eventually a commission, albeit a less-than-full one; and the tenant benefits by virtue of, among other things, being associated with the system, which comes at no expense to the tenant because the amount of the system percentage of the commission is unrelated to the purchase or lease price, so the tenant does not have to worry about agreeing to a higher price than it normally would since the commission formula and the timing of its establishment affords the broker no ability to affect the transaction cost agreed to by the principals to the transaction.

Real estate transactions may provide a preferred sector from which to generate system resources because real estate professionals often cannot modify their compensation in order to offset the portion being allocated to the system. Instead, in the case of sales, the commission frequently is a function of the sale price of the subject real estate. In the case of leases, depending on the jurisdiction, the commission also may be a function of the lease cost. It is this fact that, in real estate, the compensation or commission formula (based on either a sale or lease cost) is fixed at the beginning of the transaction that makes real estate a favorable resource source for the system, from the perspective of the consumer.

Transactions involving, among other things, residential real estate purchase and sale, commercial real estate purchase and sale, and commercial leasing may all be potential sources from which funds may be generated. In addition, transactions in areas other than real estate, particularly those in which commissions are generated, may provide additional sources of funding. Like the real estate transactions described above, these other transactions may have similar consumer/service provider dynamics, which may include supply and demand-type or fiduciary-type dynamics, and service provider compensation dynamics. Alternatively, the system may obtain resources via transactions involving the commerce of goods and services.

The system and method may set a minimum amount required to be generated from each transaction. For example, a minimum percentage of the commission, e.g., about 5-10%, may be allocated automatically to the system. However, this level may only be a floor and may not foreclose the opportunity to allocate a larger amount of funds. For example, consumers may negotiate with their fiduciary agents, e.g. real estate brokers, for remittance of an increased percentage, e.g., about 10-15%. In this case, the broker forgoes a larger percentage of its commission, but it still receives a portion of a commission as opposed to no commission at all. As an added incentive to the broker, the system may display and/or give recognition to brokers that have agreed to remit increased percentages of their commissions, which may provide that broker with greater user visibility or renown and increased future transactions.

The system may allocate a portion of the resources generated from these transactions towards administrative or other costs. Preferably, however, a large percentage of these generated resources, e.g., about 80-90%, may be distributed to member NFPs or for other philanthropic purposes, as discussed below. Still more preferably, approaching about 100% of the value of transaction-related generated resources may be so distributed. Additional value may be achieved by offsetting administrative and other costs with resources from other sources, as discussed above.

To further one of the system's goals of benefiting communities, as the system accumulates resources, it may interact with organizations or institutions that share in this goal. For example, resources may be deposited with organizations that support and/or engage in community development lending to provide those organizations with additional resources with which to further that goal. Such relationships further may form a source of resource generation. For example, the system may require that a portion of the profit generated from acquisition of these deposits be reverted back to the system.

In addition to the funding sources described above, the system may generate further resources through licensing or franchise fees. Other sources of funding may include, among others, fees to nominate a NFP for an election, fees for certain entities to vote in elections, and fees to use system recordation tools.

Resource Division Module

Once they have been accumulated, the system may fraction revenues, providing differing treatments for different revenue streams. For example, participation-fee revenue may be treated differently than transaction-related revenue, whereby revenue derived from the latter may require that a greater percentage be distributed to NFPs on the basis of geographical location of the involved transactions.

Smaller percentages of resources from the various streams may be dedicated to local NFPs in accordance with the degree to which each stream is unrelated to a transaction or its participants. For example, corporate sponsorship resources may be less dedicated to local distribution, as may be resources resulting from higher level participation fees intended to generate wider geographical distribution of that participant's prominence among other users of the system.

One purpose of this fractioning may be to divide resources into general election and special election funds, as discussed below. Another purpose may include making some percentage of the funds, ideally from each election, available for distribution to benefit local, regional, national, and international causes. However, this effect also may be achieved simply by the ongoing rotation of candidate NFPs.

Fractioning formulae may be adjusted, from time to time, in order to make the system more adaptable to changing circumstances to distribute resources as needed or as desired. One benefit of adjustment would be to permit events such as natural disasters and states of emergency to be served in greater measure when they occur. For example, one fractioning formula may divide resources into about 60% local, about 30% national and about 10% international. Another fractioning formula may allocate about 90% of the accumulated transaction-based fees to NFPs supporting local causes. Yet another fractioning formula may allocate about 50% of membership based fees to local causes. Still another fractioning formula may allocate about 100% of resources derived from internet traffic monetization for international causes or system administration expenses. These formulae are intended to only be exemplary, and other fractioning formulae are possible.

In addition to the distribution of resources via elections, at least a portion of the accumulated resources may be distributable solely at the option of system managers or by the system itself. For example, resources acquired via advertising may be subject to distribution by the system without election by the members of the system.

In one embodiment, accumulated resources may be distributed as “unrestricted” to the NFPs that secure those resources based on election results, as described below. In still another embodiment, the system may allow for earmarking of certain resources to be distributed to the NFP or causes of choice of the entity responsible for providing the resources. Preferably, resources available for earmarking may comprise those obtained from real estate or other transactions. Where a given set of resources is generated through a real estate transaction, the resource provider may include either or both the real estate professional and its principal for that transaction. In this example, the resource provider may select any number of causes from a predetermined list of causes to which resources should be distributed and further may select the proportion of resources generated from that transaction to be distributed to each of those selected causes. This earmarking possibility may increase participation in the system by potential funding participants by strengthening or heightening the participant's level of personal involvement or satisfaction and the participant's perceived and real degree of control over its contributed funds. For example in one embodiment approximately 75% of system revenue from a transaction may be earmarked by the principal and/or its broker with the requirement that no fewer than three causes be selected for earmarking with no less than about 15% of the amount being earmarked for a single cause.

In this embodiment, the system may provide a series of codes to identify various causes and the NFPs supporting them. Information about NFPs may be searchable via keyword or through these codes. In addition, these codes may be used to escrow and/or allocate earmarked resources and may serve to provide notice to the system of a resource provider's desire to have its resources earmarked. For example, a participating resource management institution such as a banking facility, or the system itself, may have forms or an online submission process that queries or prompts the provider to indicate whether it wants to earmark resources and, if so, to indicate the corresponding codes of the desired causes or institutions. If any codes are provided, the funds then may be segregated, e.g., for accounting purposes, on that basis and according to the criteria set forth by the funding-participant.

Also in this embodiment, the voting module (described below) may organize an election to distribute funds among one or more of the NFPs supporting the earmarked cause. Additionally, the election module may allow the electorate, or some part thereof, to submit or nominate additional NFPs serving that cause to add to the slate of nominees eligible for funds.

Education Module

According to one embodiment of the invention, certain users, and potentially all users, may be eligible to vote on the distribution of funds. However, in another embodiment, the system or method may require a user to verify that it has achieved a predetermined level of knowledge regarding the activities of one or more of the potential funding recipients. As such, the system or method may include an education module to teach or otherwise inform the user about those candidates' activities. One example of a link to an education module may be seen in FIG. 1 under the heading “Discover Non-Profit Organizations.” Selecting the “Find” option may allow a user to search and retrieve information about various NFPs, as discussed herein.

The education module may include at least one database of information about the various NFPs to which resources may be allocated. This database may include a profile containing information submitted by each NFP and also may be augmented or added to by contributions from other system users. In addition to this information provided by the NFP, each NFP may be required to provide an Internet link to one or more of its websites that contain information about the NFP and its causes. Moreover, a precondition for registration and/or nomination may be for the NFP to provide a similar link to the system on the NFPs website.

The information in the database may include, e.g., information about the NFP, information about the cause or causes advocated by the NFP, and information relating to the NFP's proposed solutions or actions relating to those causes. In one embodiment, the information in the education module may be sortable and viewable by geography, common interest, common age, etc. Each of these different options may be seen as a community within various communities, and the user may see himself as a member of each of these different, yet interrelated, communities.

The database in particular, and the system in general, may be searchable to allow users to home in on desired NFPs. In one embodiment, the system may include a text-based search to find keywords contained in the NFP-submitted information or in the message boards (discussed below). In another embodiment, each NFP may be required to provide certain identifying information, such as the geographic location it desires to serve, the causes it advances (eliminating disease, fighting poverty, e.g.), the organization size, etc. Users then may be able to search for NFPs according to one or more of these identifying criteria to determine those NFPs and/or causes that most closely align with their interests.

The information that the education module provides to users preferably may be of a factual nature so as to facilitate automation in the evaluation module, as described below. The NFPs seeking resources may submit information about themselves, their causes, and the ways in which serving those causes may increase social consciousness and responsibility. Additionally, information about the NFPs may be submitted by the system users.

The education module may contain and display information through a variety of media. These media may include text-based information, audio files and video clips. This information may be embedded directly in the education module display, or it may exist externally and have its location linked within the education module, e.g., as with video clips hosted on sites such as YouTube.

Submitted information may be categorized with varying levels of user appropriateness, including tagging different pieces of information with different age appropriateness levels or with language flags if information is submitted in a variety of different languages. Then, the education module may access each user's identifying information to determine what content to display to that user. For example, the education module may access the user's identifying information to cross-reference the user's age with the age tags attached to the NFPs submitted information to determine and then display only information tagged with an age appropriateness at or below the user's age.

In addition to ensuring that material viewed by the user is appropriate for that user, e.g., age-appropriate, the effect of cross-referencing may carry on to the evaluation module, generating evaluations with different levels of content for different user levels. For instance, evaluations to 6^{th} grade users may be more simplistic than those to 12^{th} graders.

In one embodiment, the education module may correlate with, or otherwise complement, a user's educational curriculum. For example, in the case of a group of students in a common classroom or grade, the users' teacher may request the users be exposed to an NFP or a group of NFPs related to a cause about which the teacher desires the students know more. For instance, a history teacher teaching about military conflicts may request an election of resources to a variety of NFPs that support veterans' causes, thereby requiring the students to become educated about these causes in order to be eligible to vote in the election.

Evaluation Module

In order to attain eligibility for elections, the system may require users to pass an evaluation relating to what they have learned about the various NFPs that vie for the resources that are part of the election. This evaluation may be in the form of a series of questions such as multiple choice and/or true/false type questions that may relate to the cause for which the NFP works or to the NFP itself. In this way, the NFPs may submit a larger number of questions than will be asked, and the evaluation module may select and randomize the questions it decides to ask in order to enhance the uniqueness of each user's evaluation, providing an incentive to the user to learn the information supplied in the education module, thereby increasing the efficacy of that module. In addition, the system may be able to automatically grade these evaluations, providing efficiency in the execution of the evaluation module.

In an embodiment where users undergoing evaluation comprise students, the evaluation module may be configured to allow for customization of evaluations by superiors, including teachers or other educators. For example, as discussed above, a teacher may wish to educate her students about a particular cause and test the students on their knowledge. In this case, the system may allow the teacher to flag the set of users that coincides with her student set. Additionally, the evaluation module may allow the teacher to select common evaluation questions or create her own evaluation. Then, when the student-users access the evaluation module, the system may cross-check the user to see if he or she has been flagged for the specialized evaluation or whether the system should create a randomized evaluation.

The system may set a limit on the number of times a user may choose to be evaluated for a given election. Preferably, however, a user may be allowed to access the evaluation module and partake in an evaluation as many times as necessary until either the user passes the evaluation or the election closes. The primary objective may be to pass the users and not to fail them so that as many users as possible may be able to vote in a given election. In this way, the evaluation module may balance the desire for a large voting pool with the desire to ensure that the users learn something about the slate of election candidates prior to voting.

In another embodiment, the evaluation module may include a subjective component in addition to the objective component described above. For example, the evaluation module may allow a user to upload or otherwise submit essays or presentations concerning an NFP, a cause, or any other related topic that may be read and evaluated either by system administrators, judges, or other system users. One use for this subjective component may be voting eligibility. However, the evaluation module also may be implemented to provide other benefits to users, ranging from recognition for the submitted work to the disbursement of scholarship resources. In the latter case, the voting module (discussed below), may initiate an election to allow users to vote and decide who should receive the resources.

The education module may include a “report card” or other form of documentary history to display to a user the information he or she has reviewed. The report card may serve a plurality of uses. For example, it may be useful to users to remind them of the information on which they have been tested and the results of their evaluations or simply to identify the information to which the users were exposed in the education module if they chose to not be evaluated. Alternatively or additionally, the report card may serve as documentary proof of the user's activities, e.g., to supplement other components of his or her applications to institutions of higher education, such as college, university, grad schools, honors programs, etc.

In one embodiment, NFPs may submit profiles to the system which, itself, then generates the questions for an evaluation, which may take the form of a single quiz or a sequence of quizzes. In another embodiment, one quiz question answer may generate a follow-up question different from that generated if a different previous answer has been given.

In the embodiment where multiple evaluations are required for voting eligibility, the first evaluation may include basic, orientation-type questions asking more general-type questions about the NFPs or their respective causes that are up for election. These orientation-type questions alternatively may include questions to determine a user's ethical orientation, e.g., the user's general knowledge about the NFPs or their causes or the user's predisposition for or against those NFPs or causes. In the multiple evaluation embodiment, the various evaluations may be divided based on subject matter. For example, the first round may contain global questions about the candidate NFPs common cause or geography, a second round may include more personalized questions relating to the specific NFPs, and a third round may include further technical questions relating to each NFPs efforts to address the common cause or serve the common geography.

Voting Module

In order to distribute at least a portion of the accumulated resources, the system may employ a series of elections to determine, inter alia, either or both the recipient(s) of the resources and the amount(s) to be distributed.

Voting may occur through both general and special elections. Determination of which NFPs may be eligible for resource allocation may be made on the basis of multiple factors. In one embodiment, any organization that is permitted to claim status as a NFP may be eligible. In another embodiment, NFPs may be sorted and selected on the basis of factors such as diversity of mission, geographical location of mission, size and/or characteristic of population served, size and/or characteristic of entities related to the NFP, etc. Another factor for determining eligibility may be size of NFP, which might be measured in a variety of ways, including annual budget, number of paying supporters, geographic reach, etc. Still another factor may be the sources of system resources e.g., so as to avoid potential conflicts of interest or unfairly weighted voting. For example, if colleges and Universities provide resources so as to make their students eligible for voting in special elections, those institutions may not be eligible to be candidates since their student populations may unfairly sway voting towards those institutions. Conversely, in another embodiment, providing resources to enable their students to vote may render these institutions eligible as a way to entice more institutions to contribute resources.

The nomination or identification of the slate of eligible NFPs may be determined from one or more of a variety of sources, including, among others e.g., all users, registered or otherwise, student-users, their teachers, real estate brokers, the principals that generated the resources to be distributed through the election, or any combination of the above. Alternatively, the system may generate the slate of candidates, e.g., using the criteria discussed above, by choosing all of the candidates in a similar geographic area as the voting users, or through a random selection from among all eligible NFPs.

In one embodiment, general elections may be open to all participants. In another embodiment, only the real estate professionals who have brokered a commission-generating transaction and their respective clients may be eligible to vote in a general election.

An election may be triggered at predetermined time intervals. Alternatively, an election may be triggered whenever a predetermined threshold amount of accumulated resources is reached. In addition, since general elections may be restricted to certain groups of participants or users, which groups further may be subdivided, the triggering amount may vary depending on the source of the resources. For example, real estate transactions from which resources are generated may be divided into commercial transactions and residential transactions. In this example, a threshold for commercial transactions may be $50,000 but may only be $25,000 for residential transactions.

Once a threshold value has been reached, the system may trigger a general or special election. At that time, the system may trigger a notification to inform users of the upcoming election. The notification may be in the form of an info box displayed to the user when the user visits a system-generated webpage. The notification also may take the form of an email, SMS message or other message distributed to the user.

At or before the time an election is triggered, the system also may determine the value of the resources to be distributed, which may be less than, equal to, or more than the trigger value. The election amount may be less than the trigger for several reasons. For example, a portion of the accumulated resources may be diverted to go towards special elections, to pay for operating expenses or for some other purpose. Alternatively, in some cases, the election amount may be more than the trigger. For example, a trigger value may be $50,000, but a transaction may yield resources worth $100,000. In this case, the system may determine that an amount greater than the trigger, i.e., any amount between $50,000 and $100,000 may be distributed via a general election. It likewise may determine that the distribution amount should be equal to or less than the trigger amount.

Eligibility for general elections (and/or for special elections, as discussed below), may be reset on the anniversary of the licensee's first resource-generating transaction, thus providing an incentive for the participant to continue to commit a percentage of his or her commissions and/or to maintain a chosen participation fee level.

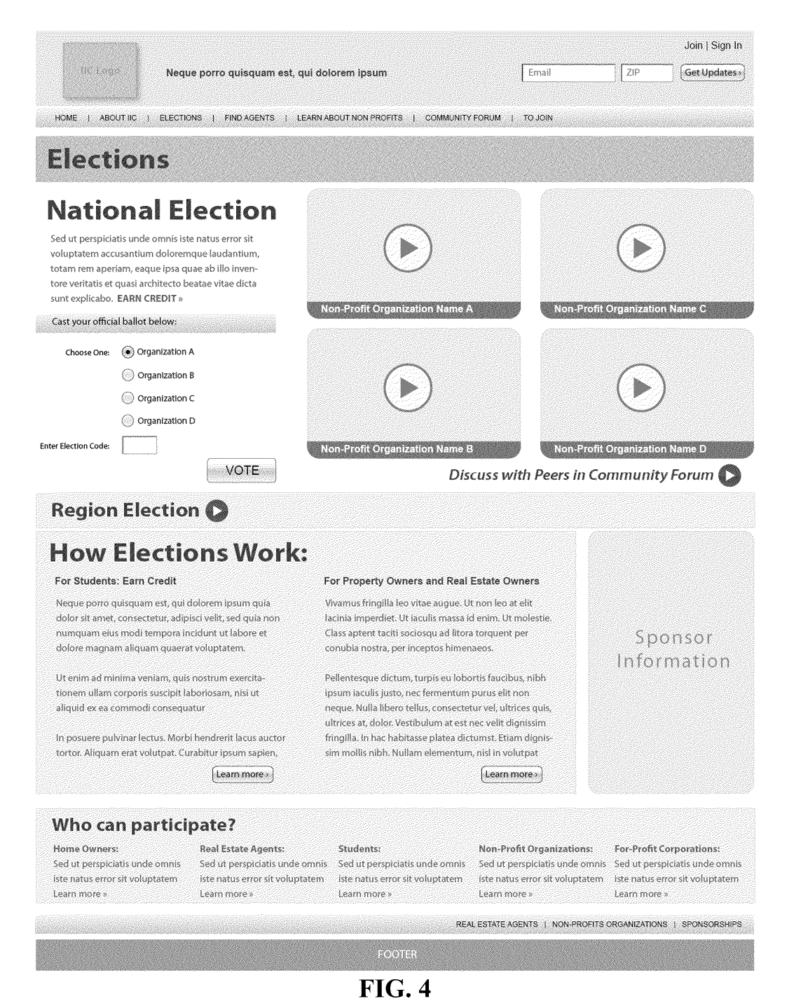

Additionally, the system may provide for special elections. Special elections may be open to those eligible to vote in general elections along with participants that have demonstrated sufficient aptitude to meet or exceed predetermined criteria established in the evaluation module as well as have met or exceeded other predetermined criteria such as geographic relevance, e.g., being registered in the same county in which revenue-generating transactions occur that fund the election or within a given distance of an area to which resources would be devoted, or minimum age. One embodiment of the voting module may be seen in FIG. 4, in which a user is able to submit a vote for one of a predetermined number of eligible NFPs and also quickly may obtain additional information about the NFP and its cause.

In one embodiment, the system may serve both as a mechanism to distribute philanthropic resources to NFPs and to educate individuals about the NFPs and the causes they serve. In this embodiment, elections may be geared towards students, particularly high school and college students, and the students may be responsible for the selection of election candidates.

Colleges and Universities may choose to have their students be eligible to participate as voters. These institutions may remit a participation fee that varies depending on the sizes or make-ups of their student bodies. With regard to the latter, institutions may pay less for student populations having a larger number of instate students and more for populations with greater percentages of out-of-state eligible student voters. In addition, by virtue of paying for their students' participation eligibility, the system may allow these institutions to select the elections for which they desire their students be eligible to vote. For example, a university may be allowed to restrict student voting to elections above or below a selected resource value amount. Additionally or alternatively, they may restrict elections on the basis of the candidate NFPs that are nominated in a particular election.

The voting module may allow for an election process that resembles elections in U.S. politics, in that there may be multiple rounds of primary and/or run-off elections preceding a final election. A related feature may be the awarding of some level of resources to the NFPs involved in the various run-off or primary elections. Multiple elections may foster a greater level of interest in the system on the part of the specific NFPs in an election, the other system NFPs that may use the system as a conduit for reaching larger audiences, which may be comprised of desirable demographic groups, and NFPs and others that are not yet involved with the system. This increased interest may result in the NFPs providing additional information about themselves and their causes to system users, e.g., through enhanced content in the education module, increasing the possibility for, and breadth of, learning by those system users.

Voting may be on a one-user, one-vote basis. With respect to special elections in particular, however, votes may be weighted. For example, students, business employees, NFP employees and other NFP supporters all may be eligible to vote in special elections. In this case, student votes may be weighted to count more than other votes. This may be so for several reasons. First, student votes may be less inherently biased than other votes, such as those from NFP employees. Second, the system may be configured to require only certain users, e.g., students, be evaluated for voting eligibility. These evaluated users may have greater knowledge about more of the NFPs by virtue of the evaluation process and, as such, may have votes weighted higher than those of other users.

As discussed above, the system also may provide for primaries or sub-elections, e.g., providing an institution such as a school district with a certain amount of resources and then enabling the institution to parse those resources into subsets and set up elections for each of those subsets. For instance, a school district may allow all students in each grade to allocate resources to the NFP of the grade's choosing or allow all students in each school within the district to allocate resources to the NFP of the school's choice.

To encourage voting, and to allow users to track the progress of a particular election, the voting module may tabulate and display votes in real time. Vote display may occur once voting is closed but also may be available at any time after voting has begun. In addition to displaying a total vote count and breakdown, vote display may be sortable, e.g., by geography, constituency, etc.

NFPs may be organized in terms of size, cause, geography or other criteria. Similarly, elections may be organized by creating ballots of NFPs that share at least one of these similar criteria. Preferably, NFPs eligible for a given election may share a common geography. However, the system allows for a single election to include local, national, and international NFPs corresponding to the geographical fractioning/distribution aspect. Still more preferably, voters for an election may share the same or similar geography as that of the eligible NFPs. As users may be required to provide certain identifying information, including date of birth/age and city of residence, determining what users are eligible for a given vote may be accomplished by comparing the desired criterion or criteria to the user's information to determine if a sufficient match exists.

It another embodiment, the system may be organized in relation to any size of geographical area or other subdivision. This may be accomplished in a hierarchical or tiered way through system architecture, e.g., by sorting users according to their respective zip codes, dates of birth, etc. As a result, the system may provide displays unique to each of these user subsets, with advertising, NFPs, and elections unique to these subsets.

In yet another embodiment, elections may be of broader scope, e.g., nationally. This may result in a larger pool of eligible NFPs from which to choose, a larger number of voters and a larger amount of resources to be distributed. In addition, this broader scope may encourage users to build a larger community or to gain interest in non-local causes.

In still another embodiment, the system may distribute surveys or monitor topics discussed in the fora to determine those NFPs for which an election should be held. In this case, the various NFPs in an election may not share any similar characteristics or criteria other than the fact that users have expressed interest in them.

Once an election has closed, resources may be distributed according to the results of the election. In one embodiment, a “winner-take-all” format may apply, providing all allocated resources to the NFP with the highest vote count. In another embodiment, resources may be allocated proportionally to all vote-getters. In yet another embodiment, resources may be allocated to the top several vote-getters, e.g., the top three. These resources may be allocated equally, in a tiered fashion, or in some other form. These distribution formats are exemplary, and other distributions are within the scope of the invention.

In a further embodiment, the voting module may include a sub-voting module or modules in which users vote to establish the slate of NFPs for a given election. For example, elections may occur in stages or rounds, whereby a NFP garnering the most votes in one election moves on to face off against different NFPs that obtained the most votes in separate elections, with the winner of that election receiving the allocated resources. According to this example, if resources are allocated to an election where the voting population comprises the students of a given school, a first series of elections may be made on the level of homerooms within each grade. A second series of elections may pit the winner of each homeroom-based election against each other on a grade-by-grade basis. Similarly, a third election may comprise the winners of each grade-based election for a final, school-wide election to determine the recipient(s) of the allocated resources.

The system may decide the form in which resource allocation may occur, likely before voting opens for the election. In the case where resources are allocated to some sub-unit of users, providing the sub-unit with the opportunity to set up its own election, the system further may allow that sub-unit to determine the manner in which those resources are to be allocated.

The system also may include features for allowing administrators and/or users to analyze the distribution of resources. For example, the system may include tools to tabulate all resource distributions for a given period of time. The system also may allow a user to sort distributions according to similar criteria as for viewing voting results. In addition, users may be grouped into units such as schools, chapters, states, etc., and resource distribution may be sortable according to these units.

In still another embodiment, the voting module may include a sweepstakes or rewards sub-module to provide further motivation to users to participate in the system. In this embodiment, a user's vote may trigger an entry in a sweepstakes for the awarding of resources to that user. As with resources allocated to NFPs, sweepstakes resources may be unrestricted or may be designated for a particular purpose. These sweepstakes resources may be allocated for personal use, such as serving as a source of scholarship funds. Alternatively, sweepstakes may be structured so as to provide winners with the ability to award those resources to the NFPs and/or causes of their choosing.

Additionally, the system may include various sweepstakes triggers. For example, each election may include a respective sweepstakes. Alternatively, a sweepstakes may be triggered by the passage of a predetermined length of time from a previous sweepstakes. A sweepstakes also may be triggered once a predetermined resource accumulation level has been reached.

Social Interaction Module

One of the goals of the system may be to foster a sense of community among users. To foster these goals, the system may include a social interaction module, which may be closely related to the education and voting modules. For example, second grade students in a shared classroom trying to choose an NFP to be placed on an election slate or to determine which NFP on a given slate should receive their votes may discuss a variety of issues and then decide jointly on an outcome. Other system objectives may be to build self-esteem, engagement and empowerment of these student-users. As such, the system may provide fora such as discussion or message boards to allow voters to lobby or otherwise discuss voting regarding a particular NFP or issues of interest unrelated to a specific election. Returning to FIG. 4, access to these fora may be obtained via a link originating on a voting module display page.

These discussion boards may be limited to discussing the NFPs up for election. In addition to serving as a forum for lobbying for a cause, these boards also may provide a source of additional information about the NFPs up for election than what is presented in the education module, thereby further enhancing a user's exposure to, and knowledge about, the participant NFPs. The system also may interface with the education module and provide for fact-checking or moderation by the system and/or its users to ensure the accuracy of information in the system databases or in the information presented to users. Moreover, the fora may encourage interaction among users in similar or different age groups, geographical locations, disciplines, etc.

Either or both the social interaction module and the education module may allow a user to access and participate in conversations or symposia with influential or prominent people, e.g., Nobel laureates, Pulitzer prize winners, sports figures, entertainers, etc. To facilitate these conversations, the system may provide for real-time question or comment submissions, presented according to conventional methods. The system further may allow for continued interaction with these people, e.g., via email, messaging, blogging, etc.

The system may provide a process by which users may learn about and become involved in the world, to truly expand their horizons intellectually and emotionally. In addition, it may provide a facility for users to interact with various groups, including their peers, teachers and mentors, parents and other adults with whom they are related in a variety of ways, in the activity of learning about and becoming involved in helping to cause positive change. The system may be a portal through which each of these groups can investigate the world, near and far, to identify problems or causes about which they feel emotionally and intellectually connected, so that they are motivated and enabled to participate with one another in directing resources toward effecting change.

In one embodiment, the system may be web-based to the maximum extent practical to take advantage of benefits including scalability, efficiency of operating cost, and monetization of internet activity. The system further may comprise an expandable, robust, web-based directory of information about which a visitor may be curious and will include ways of allowing those visitors to become involved. A user may identify a single issue or problem and work toward directing resources to a single NFP, which is dedicated to that cause. Another user may feel that there are many causes calling for their efforts. In either case, the system allows each user to learn more about those causes and work towards directing resources to those causes.

The system further may utilize an ever-expanding system of interconnections via links with NPFs, social media tools, and conventional marketing tools.

Recordation Module

In another embodiment, the system may include a module that allows users to record their philanthropic work. This module may include a log, diary, spreadsheet, database or other record of the user's community service efforts, including work performed, time spent and/or resources donated.

The recordation module, which also may be viewed as an electronic portfolio, may interface with the education, evaluation and/or voting modules to import relevant information from the system. For example, the amount of time spent learning about NFPs in the education module or the user's voting history may be transmitted into the recordation module. This transmission may occur automatically, or it may happen upon the user's request.

In addition, the recordation module may allow the user to track philanthropic efforts external to the system, providing a centralized location to memorialize his or her efforts.

The recordation module also may serve as a source of funds, with a fee required for access and/or record maintenance.

Several benefits that may result from the system and method may include: educating and empowering students, strengthening the real estate profession or (an)other profession(s) from which financing may be derived, marketing businesses, assisting the consumer, funding NFPs, building communities, and supporting community development lending.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A system for the disbursement of philanthropic resources via voting over a computer network, comprising:
a resource accumulation module;
an education module;
an evaluation module; and
a voting module.

2. A system according to claim 1, further comprising a resource division module.

3. A system according to claim 1, further comprising a recordation module.

4. A system according to claim 1, wherein said resource accumulation module receives resources generated from real estate transactions.

5. A system according to claim 4, further comprising a searchable database of agents facilitating said real estate transactions.

6. A system according to claim 1, wherein at least a portion of users must access said evaluation module in order to access said voting module.

7. A system according to claim 1, wherein said voting module establishes elections for disbursement of said resources.

8. A system according to claim 1, wherein said voting module establishes preliminary and general elections.

9. A system according to claim 1, further comprising a discussion forum.

10. A process for the disbursement of philanthropic funds via voting over a computer network, comprising:
accumulating resources from a plurality of sources;
allocating at least a portion of said resources to an election, wherein candidates for said election comprise a plurality of not-for-profit entities;
educating users about said plurality of not-for-profit entities;
evaluating said users for knowledge about said plurality of not-for-profit entities;
allowing said users to vote for at least one of said plurality of not-for-profit entities to receive said allocated resources;
tabulating said votes of said users to determine at least one recipient not-for-profit entity; and
distributing at least a portion of said allocated resources to said at least one recipient not-for-profit entity.

11. A process according to claim 10, wherein said users vote by accessing a voting module.

12. A process according to claim 10, wherein a provider of said allocated resources assigns said allocated resources to said election.

13. A process according to claim 12, wherein said election comprises a vote among said plurality of not-for-profit entities, said entities having a cause in common.

14. A process according to claim 10, wherein said resources are distributed to said plurality of not-for-profit entities in proportion to said tabulated votes.

15. A process according to claim 10, wherein said resources are distributed to between the top 1 and 3 vote recipients.

16. A process according to claim 10, wherein said knowledge is provided by said not-for-profit entities.

17. A process according to claim 10, wherein said knowledge is further provided by other system users.
